(19) United States
(12) Patent Application Publication
(10) Pub. No.: US 2008/0133603 A1
(43) Pub. Date: Jun. 5, 2008

(54) SYSTEM AND METHOD FOR MEDIA PUBLISHING

(76) Inventors: Lawrence Fischer, Chestnut Hill, MA (US); Douglas Berrett, Seattle, WA (US); Joshua Kampel, Medford, MA (US); Mark Weary, Billerica, MA (US)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 11/846,240

(22) Filed: Aug. 28, 2007

Related U.S. Application Data
(60) Provisional application No. 60/840,736, filed on Aug. 28, 2006.

(51) Int. Cl. G06F 17/30

(52) U.S. Cl. 707/104.1; 707/E17.009

(57) ABSTRACT

A method and system for publishing a media set. The method includes selecting a publishing platform, compiling a set of data regarding the media set, analyzing the set of data, creating a playlist based on the analyzing the set of data for said media set, and publishing the media set on the publishing platform.

### PRIORITY

This application claims the benefit of U.S. Provisional Application No. 60/840,736, filed on Aug. 28, 2006, and which is incorporated herein by reference.

### FIELD OF THE INVENTION

The present invention is directed towards media publishing, and more particularly towards a system for providing in-store media presentations over a myriad of different display devices.

### BACKGROUND OF THE INVENTION

Consumer products providing information in a published media take various forms, such as television commercials, newspaper and magazine advertisements, mailings, point-of-sale displays, outdoor billboards, etc. Using current advertising media, advertisers engage in a constant struggle to efficiently use their budgets to most effectively reach their geographic and demographic targets. Many forms of advertising techniques have remained essentially unchanged throughout the twentieth century.

### SUMMARY OF THE INVENTION

One embodiment of the present invention is a method of publishing a media set. The method includes selecting a publishing platform, compiling a set of data regarding the media set, analyzing the set of data, creating a playlist based on the analyzing the set of data for the media set, and publishing the media set on the publishing platform.

Another embodiment of the present invention is a system for publishing a media set. The system includes a platform to display the media set, a system administrator, the system administrator views and analyzes a data set, a content administrator, the content administrator analyzes the data set, a content publisher, the content publisher creates, edits and manages the data set for the media set, and a publishing manager, the publishing manager views and publishes the media set on the publishing platform.

### BRIEF DESCRIPTION OF THE DRAWINGS

The foregoing and other features and advantages of the present invention will be more fully understood from the following detailed description of illustrative embodiments, taken in conjunction with the accompanying drawings in which:

FIG. 1 is a block diagram illustrating one embodiment of the present invention;

FIG. 2 is a block diagram of how assets are handled and grouped according to one embodiment of the present invention;

FIG. 3 is a hierarchy diagram of system control categories for an illustrative embodiment of the present invention;

FIG. 4 is an example administrator screen for managing playlists according to one embodiment of the present invention;

FIG. 5 is an example administrator screen for editing playlists according to one embodiment of the present invention;

FIG. 5A is an example of a playlist editing including control of meta-data and targeting of playlist to system types;

FIG. 6 is an example administrator screen for information assets (such as side banners) according to one embodiment of the present invention;

FIG. 6A shows an example administrator screen in asset edit mode;

FIG. 7 is an example administrator screen for movie assets according to an embodiment of the present invention;

FIG. 7 A an example administrator screen in edit mode;

FIG. 8 is an example administrator screen for shells (such as branding) according to an embodiment of the present invention;

FIG. 9 is an example administrator screen for stores and system status according to an embodiment of the present invention;

FIG. 10 is an example administrator screen for stores and system status details according to one embodiment of the present invention;

FIG. 10A is an example of an edit system type screen;

FIG. 10B is an example showing a location edit with time for downloads and server priorities;

FIG. 11 is an example administrator screen for system types according to one embodiment of the present invention;

FIG. 11A is an example screen showing an edit of system type according to one embodiment of the present invention;

FIG. 11B is an example screen showing a list of system downloads;

FIG. 12 is an example of an agent download screen;

FIG. 13 is an example of a system download screen;

FIG. 14 is an example of a system configuration screen;

FIG. 15 is an example of a system registration screen;

FIG. 16 is an example of a client system in use including content (movie), informational panel and brand shell; and

FIG. 17 is an example of a client system in use including a table of contents screen.

### DETAILED DESCRIPTION OF THE PRESENT INVENTION

Although the description of the present invention is described in terms of in-store presentations, i he present invention may be used for any type of environment, including but not limited to, any size store, mall, any public or private venue, club, bar, disco, theatre, arena or stadium. Also, the present invention is capable of getting and displaying dynamic information, such as an RSS feed.

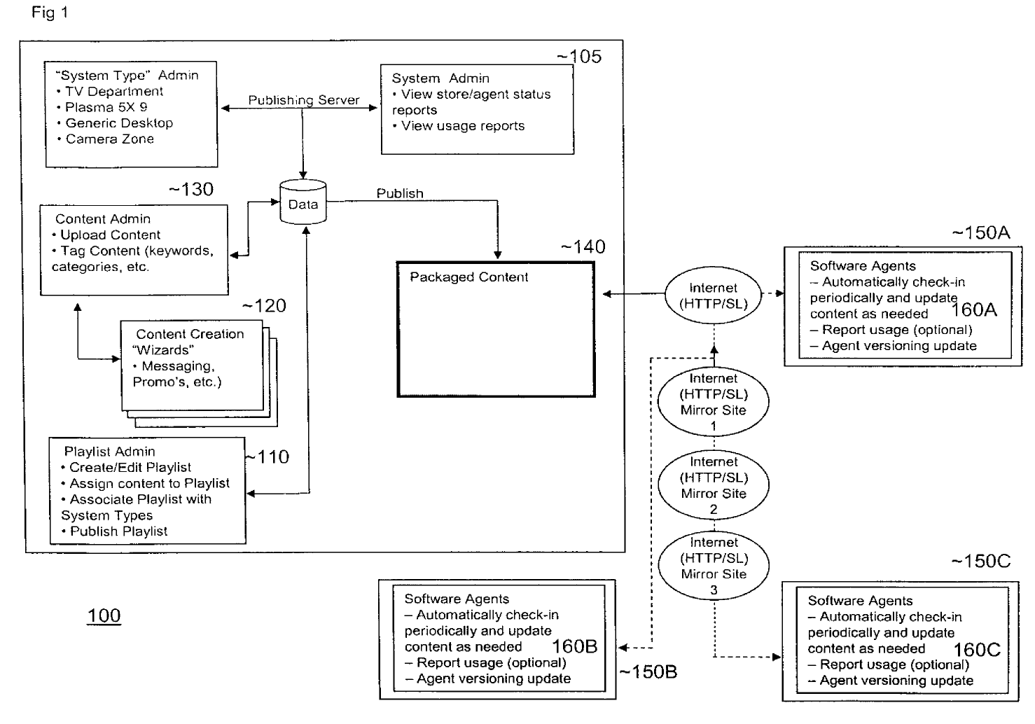

The present invention is described as an in-store publishing system that is easy to use and maintain. An illustrative embodiment, as shown in FIG. 1, includes a secure web-based publishing platform 100 managing demonstration content (or any other media) and distributing approved data to local store systems 150A, 150B, 150C in real-time or near real-time. Local application agents 160A, 160B, 160C on each system 100 coordinate the receipt of content 140 and playback of the locally stored content (typically initially installed via password protected web site). Personnel may have secure 24/7 access to the system to manage and publish content. From a retail store perspective, once the initial agents are installed on systems (i.e. computers, playback units, etc.) the daily downloading and presentation of all content is automatic.

The present invention provides, for example, store customers and other audiences with media content through a flexible interface to any configuration of displays and audio producers. Display media content includes, but is not limited to, graphics, text, animation, video (any quality, including high definition), on any type of display including televisions, monitors, screens, PC displays, laptops, etc. Audio media includes, but is not limited to, audio, music, instructions, etc., played through any output. The output includes, but is not limited to, a laptop speaker and surround-sound equipment. Other types of content include interactive scripts and applications that may interact with customers or store personnel, for example, from anything from a PC or laptop, to any other device or devices with input and/or output ability. Such content is refreshed frequently and presents a variety of themes.

All display screens in a store may display content, with centralized control, publishing (including synchronization), and management of content. The present invention delivers a full-service turnkey software/content/service solution at an affordable cost. Systems of the present invention may act in completely a synchronized fashion or independently. In addition, systems in a given venue may synchronize or unsynchronize, periodically or based on an external trigger, for example, a remote control.

Additionally, systems of the present invention are functional independent of a format of the content of the information to be displayed. For example, the content format may be an MPEG, a WMV, a TRP, an MP3 or any other file type that is compatible. The system also supports third party playback devices. Further, the system of the present invention will support playback on devices such as, but not limited to, AppleTV and Sencore equipment.

Some features of an illustrative embodiment, as shown in FIG. 1, may include:

The publishing system includes various sections, each appropriate to the user type and task. One or many tasks may be accomplished by the same user (i.e., a marketing person may administer, publish and manage the system). Further, different levels of access and editing control (e.g., viewing, modifying, deleting) may be provided for different users, groups, or departments.

A Content Administrator 130 manages various groups and/or subgroups. A group determines which content is downloaded and played on a specific store or location machine. One type of group may be a system type, for example screen size (actual size, ratios such as 4×3, 6×9, 1.6:1, wide screen, full screen, etc.), format (TV, HDTV, static images displayers, etc.), or device (PCs, Laptops, Desktops, plasma displays, LCDs, kiosks, audio only devices, etc.). Other types of subgroups may be flexibly configured for any type of display environment, such as multiple possible subgroups within a single store, or across a mall or over entire regions of a country. Subgroups may be set up and managed in any fashion. For example, certain display units may show content in Spanish at certain times or all the time. Another group may be displays and/or audio devices in various parts (or zones) of a store, for example displays in a camera section (even among camera sections over several separate stores), displays above checkouts, displays at entrances to stores, etc. Another example is PCs with interactive content available to users and customers. Because the content is interactive, the system is capable of providing a different playback sequence to target different users. Targeting may be by time of day, by calendar time period, or any other event, like a sports schedule, or certain events. Content may be automatically updated on a device, so each system will download an appropriate content based on an indication from the system.

A Content Creator 120 allows for the managing of the various asset pieces used in the final playlists (movies, shells, etc.). Functions include uploading, tagging and categorizing content.

A Content Publisher 110 allows for the managing of Playlists and Interactive Content. These playlists determine which shells (look, identity, graphics and functionality) and movies (or other interactive content) end up on the store machines. Once a playlist is created, a user may associate it with a “system type” and publish it. At intervals, a store agent 160A, 160B, 160C polls the server to see if any new content has been assigned to its system type. If so, it will be downloaded and played.

A Publishing/Marketing Manager 105 tools to view administration data such as agent reports (which agents, groups, stores or regions, etc. have/have not checked in), deactivate old agents (if the machines are no longer in the field) and view customer usage reports. Any example of customer usage reports is information about when customers interact with interactive displays, such as PCs. Other examples of possible reports include proof-of-play, or reports of performance, errors, usage, status of individual systems or in the aggregate.

A polling page is a functionality that may need to be exposed to the store networks. This includes a small set of pages which allow for agent download, registration, reporting, and content updates. Content may be sent to the client only upon authentication.

Store Administrator may navigate (via web) to publishing server, and download appropriate “agent” for the system.

A single agent may handle the televisions, plasma screens, the PCs, and the laptops, handhelds, shelf-level playback devices, etc. An agent may also control display, audio and interaction via user input (keyboard, remote, game controller, touchscreen, proximity sensors, etc.).

The agent 160A, 160B, 160C prompts the administrator for the type of demonstration they want played (via selectable list—plasma, PC, laptop, etc.), the store location, and basic system description (for support purposes), upon installation. With this information, the agent registers itself on the publishing server with a unique ID (GUID). At this point, the store administrator is finished and the agent will download the specified content and begin “playing” it. Alternatively, the agent 160 may be partially or fully automated to automatically detect its environment and set itself up appropriately. For example, an agent 160 may detect the type of machine it is installed on, determine the display (or multiple displays) type, available devices (visual or audio outputs, interactive inputs), communication connections (internet, LAN or WAN, wi-fi, Bluetooth, modems, etc.), other agents, paths to resources, etc. The agent may have a default configuration that can be general, or specific to a certain environment (such as a certain type of store).

In an illustrative embodiment, all contact with the agents is via a “client-pull” method. The server never directly contacts the various store agents (thus requiring a hole in the firewall). In this solution, the “agent” polls the publishing server (via HTTP/HTTPS) at specified intervals and downloads (pull) new content when available. Other embodiments may distribute, update or share content n various ways including server push, chaining of agents, peer-to-peer sharing, network file systems, etc.

In one embodiment, once running, the agent will run as a screensaver. In this mode, it will begin running an “attract loop” during periods of inactivity. If a customer wakes up the machine, it will start an interactive mode where the user may learn more about the system, or he/she may proceed to other screens, including if desired a different application or website for more information, or direct purchasing.

Some of the HD media content displayed to the customer through the agent is WMV-HD based, although other formats and players are all possible, including other video formats where necessary (Flash, MPEG2, etc.).

The present invention provides a digital media network that can broadcast nationwide throughout leading retailers utilizing TVs, PCs, and other types of multimedia and/or interactive displays. In ar other embodiment, the present invention may broadcast internationally. This helps provide content and advertising messages to a highly desirable audience, in many cases at the point of purchase. The present invention also provides two-way real time communications with connected locations, allowing retailers to monitor the status of individual locations and to make immediate changes to a specific location or across an entire network.

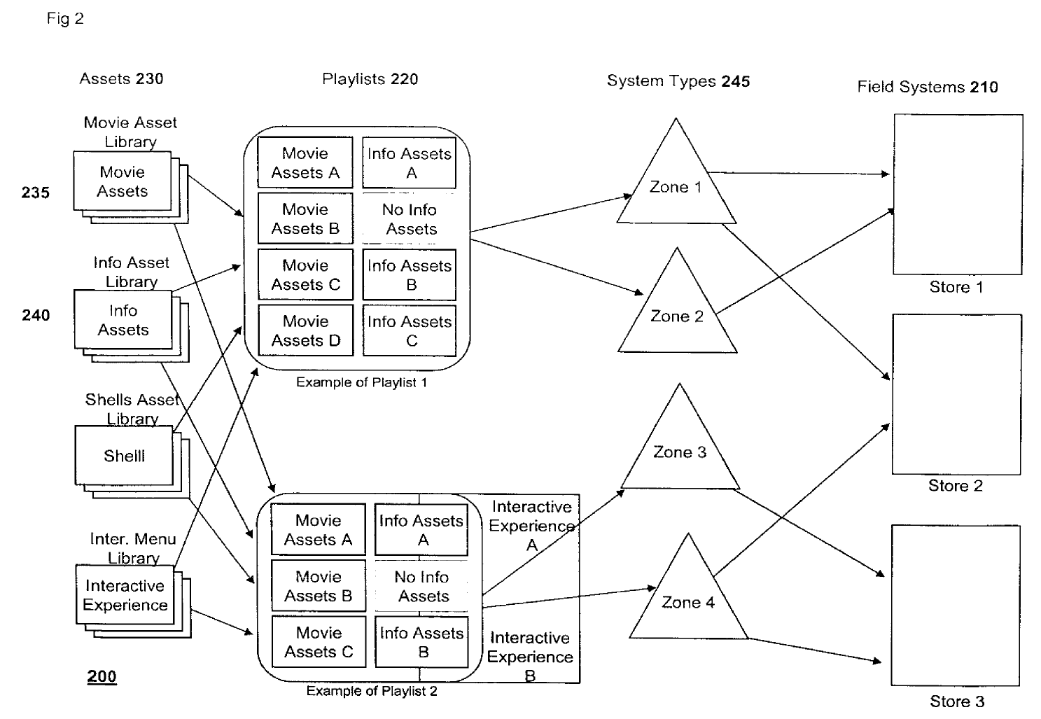

An illustrative embodiment of the present invention, as shown in FIG. 2, includes field agents 210 which are installed on various PCs or other devices to playback the content, and a central server which is in charge of managing the play lists and content that each machine will play. A playlist 220 may include various assets 230, such as, but is not limited to, movies 235 and infopanels 240, that are played inside of a branded shell. A movie is a typical media platform for viewers (essentially commercials, 1-2 minutes in length), and may be played back full-screen, or with a supplementary “infopanel” on the side (cross-selling, branding, etc.).

A playback is not limited to a single asset playback, but rather, multiple assets can be played at the same time, including both video and audio playbacks. A playback will also occur regardless of the status of the connection to the system. Systems report playback, download information and other status information. Options include switching to a non-system input source and may also be automatically switched based on an external trigger to a timed event. In addition, the present invention is capable of managing third party equipment to broaden the user experience, and is also capable of automatically updating software deployed on a remote system.

A Publishing System is an entire system that drives the display with various system types. It includes agents that “pull” from the server, as well as the backend administration screens that allows the Publisher to create, edit, update and publish playlists. An Agent is an application that in-store personnel install on the systems and which regularly “pull” the current published playlist to display on the system, as well as control launching and playback of interactive experiences. A Publisher is a person(s) who creates and updates playlists and “publishes” the playlist so that it is running “live” on the specified system(s). A Server is a computer “box” or other device that contains the application files that drive the system.

A Client is the system(s) in the field that is pulling the information off the server. There are two or more Display Shells used within the system. They are the graphic interface that display the assets. For example, there may be a shell for a 16:9 display (typical for HDTV, certain computer monitors and some laptop systems) and a typical 4:3 display for most regular TV, and desktop and laptop monitors. Other shells may be easily added and configured.

Asset 230 is an informational/promotional panel or movie and/or an interactive element created outside the system and then uploaded to the publishing system. The Asset may be uploaded by the Publisher(s). An Asset Type is an Informational/Promotional Panel or a Movie Panel or an Interactive element. An Informational/Promotional Panel is a graphic or animation file (Flash-based or otherwise) that appears on the side of the display. Informational/promotional panels usually relate to the movie panel playing to the right of it.

Assets of multiple types may be grouped for display on one or more systems, wherein such group may or may not be a sequential list. Assets may contain meta data that describe the asset, including but not limited to, its name, source, categorization and format. The system permits searching, categorization, and other operations based on this data. An asset may also be tagged with a window of time that the asset is to expire. The system may automatically cease all playback, regardless of if the asset is used in a playlist, once an expiration time has been established. The present invention is unrestrictive to the types of assets that it can manage.

A Movie Panel is a movie or animation that appears in the main part of the display. The movie panel usually relates to the informational/promotional panel playing next to it—if enabled. A Playlist 220 is a sequence of several media elements as they display on each system. Each system type (HDTV, Plasma, Generic Desktop, Laptop, etc.) may have its own associated playlist. Playlists provide the ability to control what plays, what order, when it plays, how it looks, what interactive abilities are possible, etc. Playlists may also be assigned to one or more groups and multiple playlists may be scheduled based on a time of day, day of week or any other type of schedule.

A Default playlist will display on the system if no playlist is specified for that system. A Publish Playlist is an action that makes the playlist play “live” on a specific store system. A Save Playlist in an action that allows a Publisher to save an “in-progress” playlist for future publishing. A playlist may also be scheduled based on a time of day, day of week, or some other schedule, playlists may also be assigned to one ore more system groups.

A Playback System Type 245 refers to the systems in the field that the displays run on. These include generic laptop or desktop or any specific laptop or desktop system, graphics driver device, etc. Tie user has the option for deleting, editing or creating new Playback System Types based on need A Field System 210 is a specific playback device in the store or other location. Details on each system are entered by the In-Store manager when they install the agent on that system, or manage the system remotely or automatically. In addition, the present invention may include an external device control. It can remotely schedule content being output and can also schedule the control of an external device, such as a source selector or a cable box, for example.

The present invention can generate reports based on information collected from the present invention to determine uptime, connectivity, playback condition and other status information. The present invention may also summarize and categorize system status. In addition, the present invention is scalable and flexible. Depending on the client's needs and deployment, the management of the system of the present invention may be scaled. To provide additional bandwidth for high definition assets, content servers may be duplicated and placed closer to the system, reducing point bandwidth requirements and decreasing overall network traffic. Additionally, the database may be replicated or split across many different servers to increase the overall network size. These actions may continue to occur to create an overall system size that has no maximum size.

In order for an in-store system to run a presentation, an “agent” is installed. Installing this agent is a simple process and explained in further detail below. The agent's function is to identify the system to the “home office” so that presentations designed specifically for that system can be downloaded and displayed. The agent then pulls the current playback information from the publishing system (server) at frequent intervals. Alternatively, the agent can pull or obtain content at selected times.

The publishing system holds assets created outside of the system. Flash based assets are saved at specified dimensions in order to play correctly with the display “shell”. When uploading a new asset (either informational/promotional panel or movie), the user may be asked to fill in details including asset title, description, keyword, category and total runtime. Other types of data may be imported or detailed about how to obtain the data, such as inventory data.

To create a new playlist 220, a Publisher gives the new playlist a title and enters in description an i keyword information. An Informational/Promotional Asset may be selected from the existing asset list as well as an accompanying Movie asset which will make a “mini-commercial”. Once commercials are entered, the user has the ability to sort the order to create the final playlist as it will appear on the store monitors.

The user is asked to assign a “System Type” 245 for the playlist. This designates what system(s) in the field will display this particular playlist. In order to edit an existing playlist, the Publisher swaps out informational/promotional assets and/or movie assets and update any descriptor information to identify the revised playlist correctly. In addition to manually creating a playlist, parameters may be set so that the present invention dynamically generates a playlist. For example, the playlist may comprise 25% sports and 25% entertainment with a Sony commercial every thirty minutes.

The agents communicate back to the main server via HTTP or HTTPS channels—mostly utilizing web-services. This is a pull-only model, eliminating the need to open any holes in the client-side firewall except for normal web-traffic. The agents communicate with the server for various reasons—status updates, usage reports, updated executables and new content. When an agent needs to get updated content, it has several procedures it typically follows. Each asset is typically packaged as a compressed archive file, optionally password protected. First, it may check its local library to see if the content has already been downloaded (from a previous update). If the content is not available locally, it may (if configured) check a central library on the local LAN to see if the content exists there (usually on another agent machine configured with a simple file-share). If the content is not available on the LAN, it may request the asset from the central server and download it. Once downloaded, it may test the archive, and if valid, copy it to the central library for other systems to use, and may extract it locally for playback. When an agent has determined it has the complete playlist, typically it will then switch over to this new playlist.

From a security standpoint, the “attack surface” is very small. Each field agent can run its own firewall (Windows XP SP2), and if required an additional firewall can be run on the edge router. No incoming ports need to be opened on the firewalls. All communication is accomplished by the agent over normal HTTP/HTTPS requests. Additionally, if needed, accessible IP range may be restricted to certain known IPs (minimally, just the central server). On the server-side, all traffic is normal HTTP/HTTPS requests, so very little configuration needs to be done beyond exposing the server's ports 80 and/or 443.

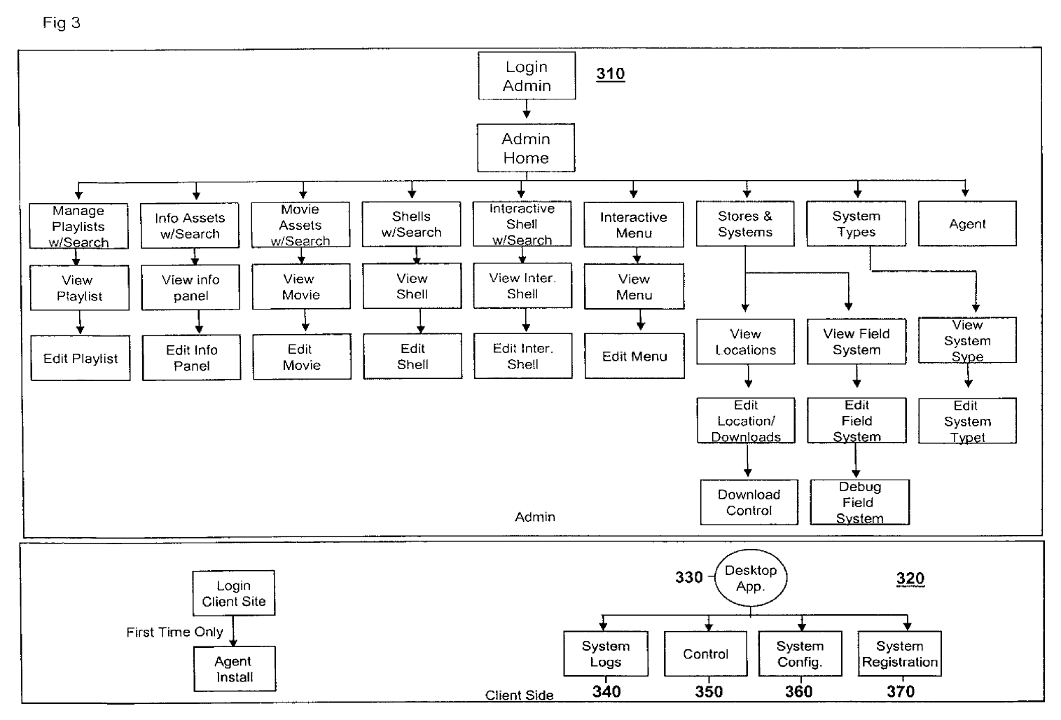

Turning now to FIG. 3, user of the system may work as follows. The following section describes the step-by-step experience and tasks for each of the system's users. The administrator 310 is described, along with the client side 320. All of these tasks may also be accomplished through the system's web interface, as shown in FIG. 1.

### Content Administrator 130:

1. Create Demonstrative Types:

a. HDTV

b. EDTV

c. Standard TV

d. Generic Desktop

e. Generic Laptop

f. Branded Desktop or Laptop

g. Portable Game Display

h. DVD Portable Player

i. Cellular Phone Display

j. Any other type of device with a display

### Content Creator 120:

1. Create Content (outside system)

a. “Movies”, Informational Panels, “Shells”, etc.

2. Upload Content to system

3. Tag content (keywords, categories, etc.)

### Content Publisher 110:

1. Create new “Playlist”

2. Add content to playlist

a. “Movies”, Informational Panels, “Shells”, etc.

3. Associate playlist with “System Types”

4. Publish playlist

a. At next interval (configurable) system agents in field get latest content for their System Type and begin playing it.

### Publishing/Marketing Manager 105:

1. View score/“agent” status reports (number of agents, last check-in, etc.)

a. Notify Store Administrator of any problems

b. Deactivate old agent registrations (i.e., system has been removed from the field)

2. View Usage Reports

The illustrative embodiment defines a simple user experience for store managers. Once the software agents are installed on a system, the day-to-day operation and updates will take place automatically.

Store Administrator/Manager 150 may perform the following:

1. Install “Agent” (from secure website)

2. Choose “System Type” (plasma, desktop, etc.)

3. Enter system “description” and location

4. Submit—at next interval system agent will get latest content and begin playing it.

### Software Agent 160 Typically Performs the Following:

### 1. Installation

a. On first run, agent registers itself with the publishing server with a unique identification

b. Agent displays a list of “System Types” to Store Administrator for choice (plasma, desktop, etc.)

c. Agent collects basic information about system: description (i.e. “Laptop Model XXX on north table”), store location

d. Agent submits collected information to publishing server, gets assigned playlist content and begins running.

### 2. Running

a. At specific intervals (configurable), agent performs check-ins with publishing server to check for new content and downloads, if needed

b. Future functionality includes ability to look in “local” location for content before downloading from master server

In one embodiment, the client side 320 includes field clients that are created by installing an agent on a desktop application 330 ranging from desktops, notebooks, server-class PCs or small-footprint kiosk PCs. Virtually all of the elements of the platform including content, status and settings can be managed via the web-based system administrator on the system server. Desktop application 330 includes a system log 340, a control function 350, a system configuration 360 and a system regulation 370.

Interactivity is another feature of the present invention, which can lead to an improvement of a customer's business processes. Users may take advantage of a content on demand feature by which they have the ability to choose from an organized selection of clips to view themed or categorized assets. In addition, users have corporate communications, wherein an access-controlled corporate communication section may be utilized to provide a means for management to deliver messaging to its employees. In addition, training may be provided interactively or passively, through a video, for example.

Guided interactive assets may be used to enable a multitude of options for a customer. PCs may be used to advertise and sell related products, as a cross-sale feature. Product information and differentiation may be implemented by using an asset that can provide data sheets and other marketing information for a specific PC or PC brand. Also, upselling may be used where an interactive asset can be used to indicate the advantages for more advance models. In an embodiment of the present invention, the system may report back usage by a tracking navigation on interactive menus or tracking certain usage, for example. This is beneficial for advertisers and retailers, for example, who would want to understand a consumer's path or their usage habits.

An inline advertisement may be placed before, after and during an interactive experience as an additional direct advertisement time. Also, an external trigger source may be used to send inputs from a TV remote to the system, for example. The system of the present invention is also capable of receiving inputs from complex or metadata driven devices to determine which assets to play or user experience to generate. Interactive usage both in terms of amount and navigation path may be tricked for individual assets and the system as a whole.

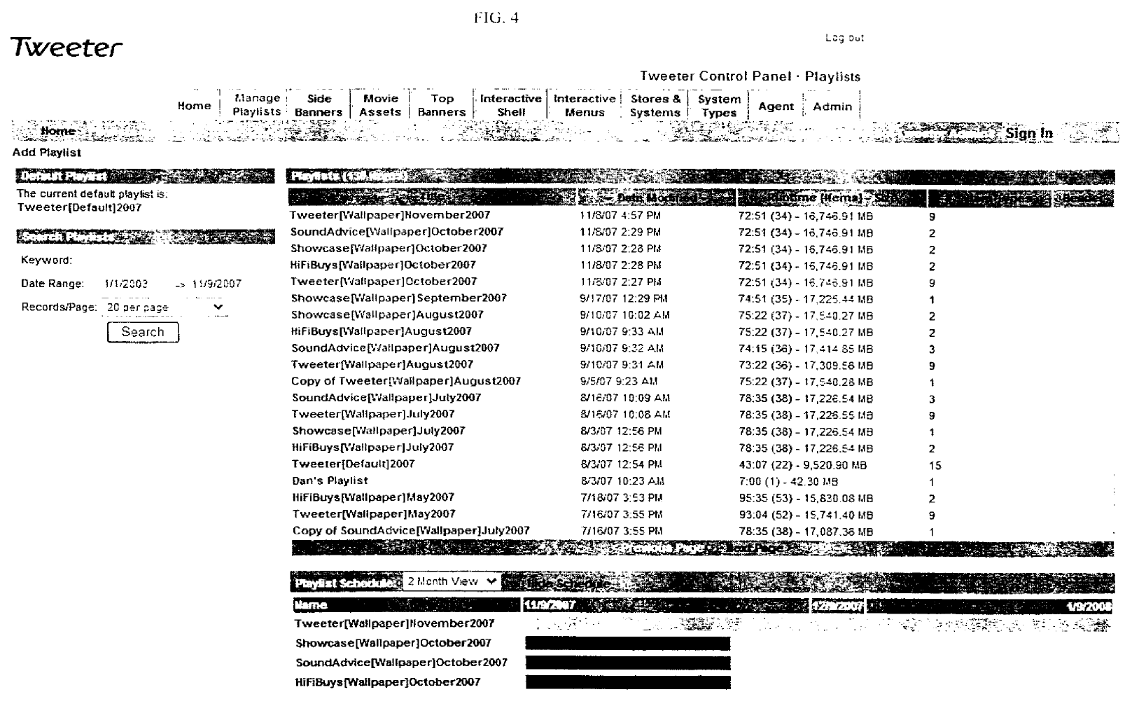

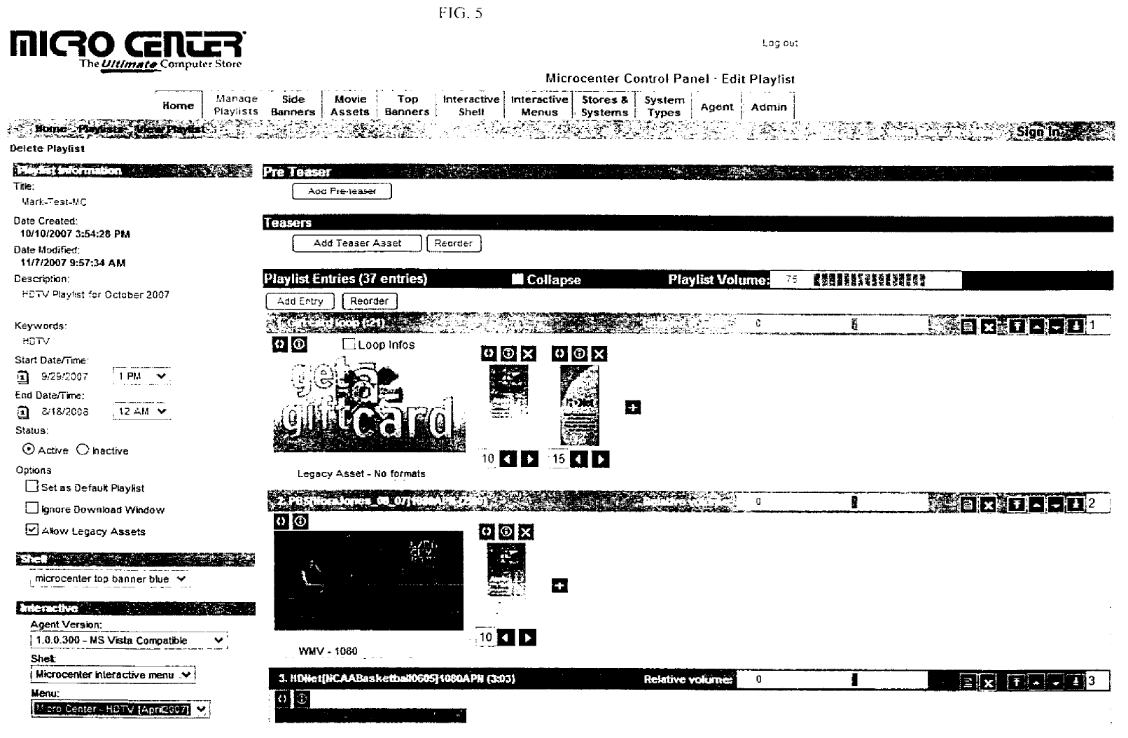

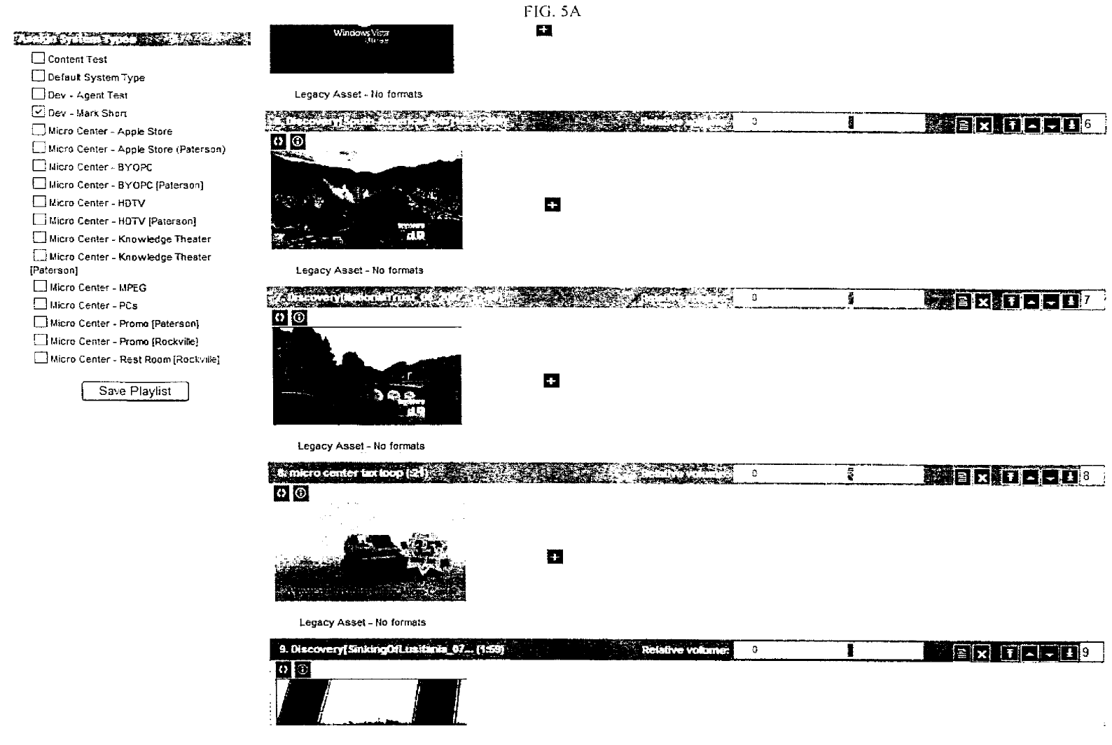

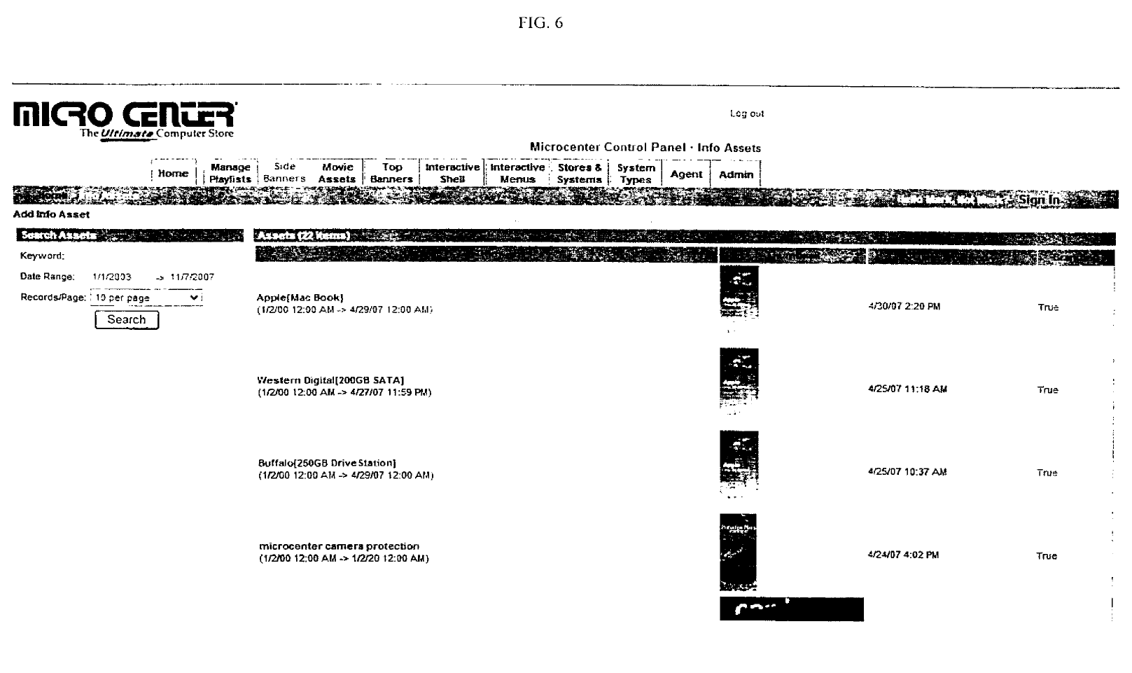

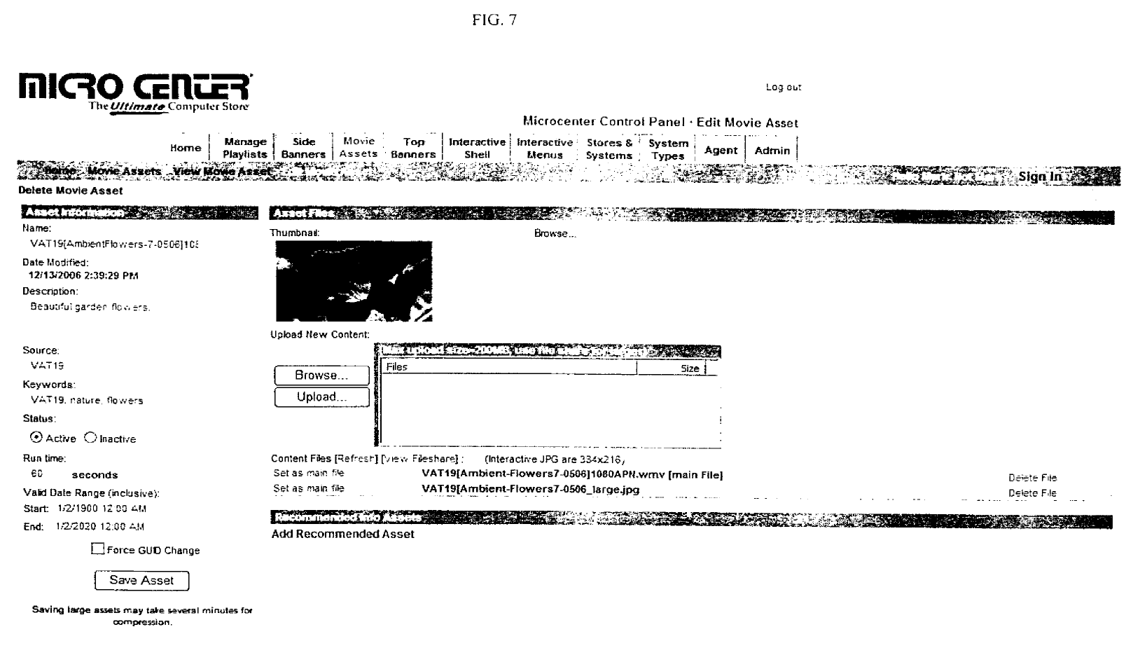

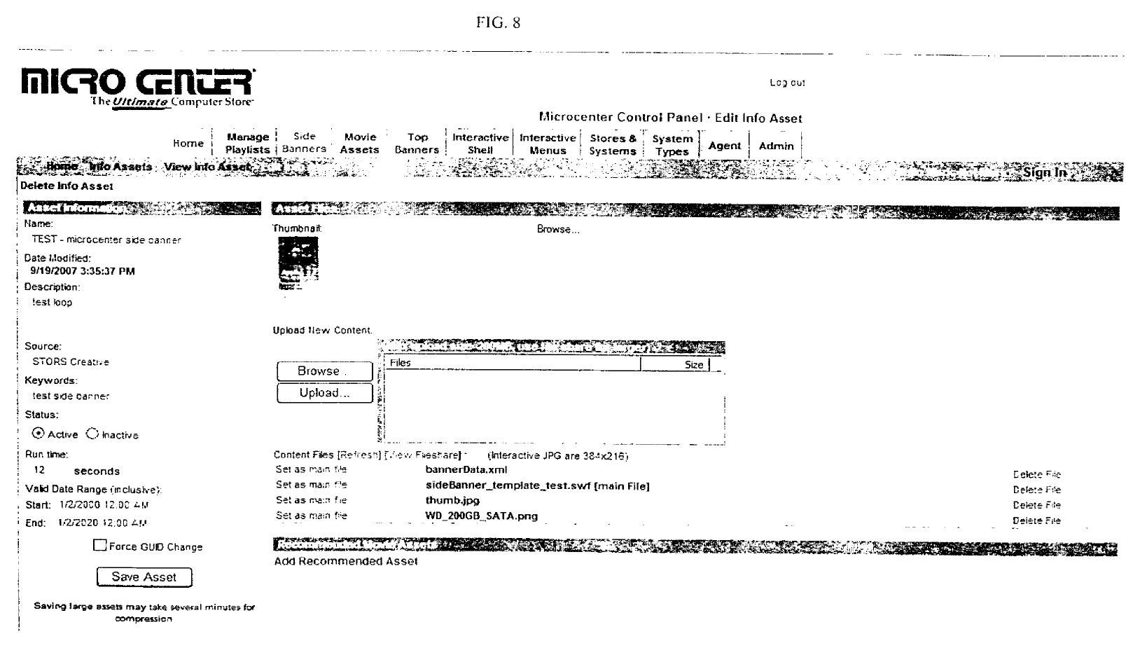

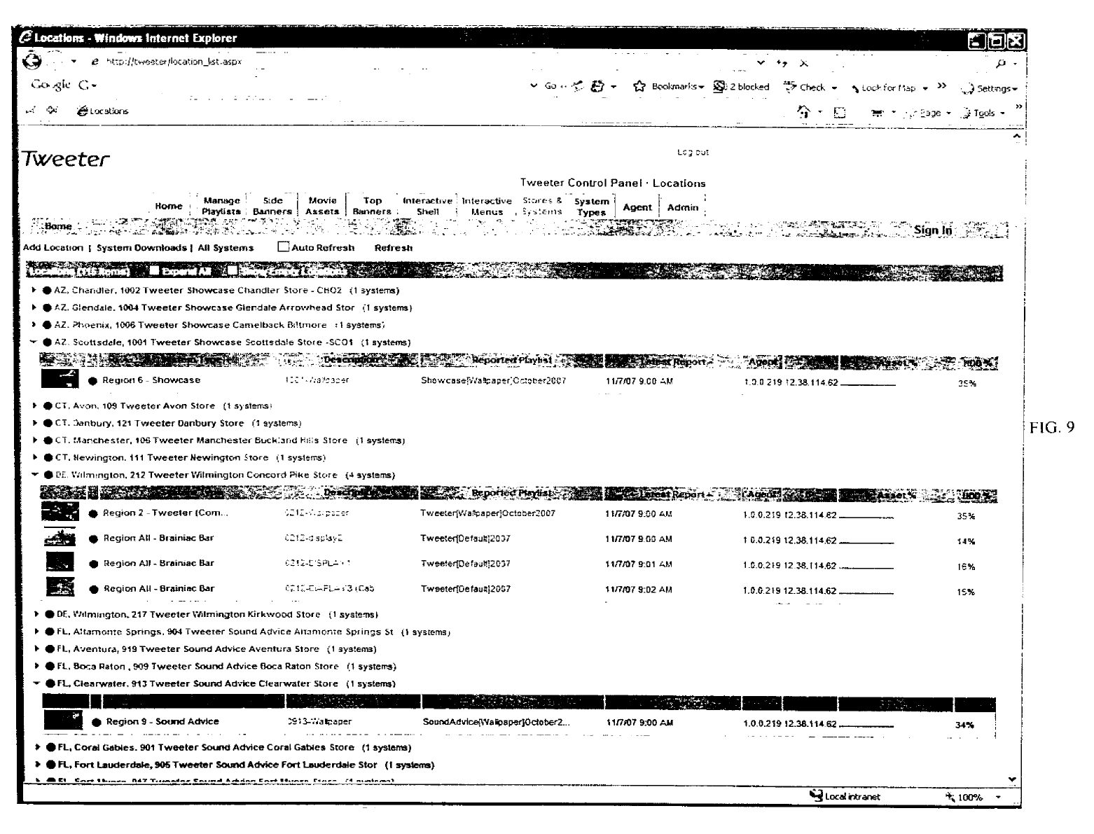

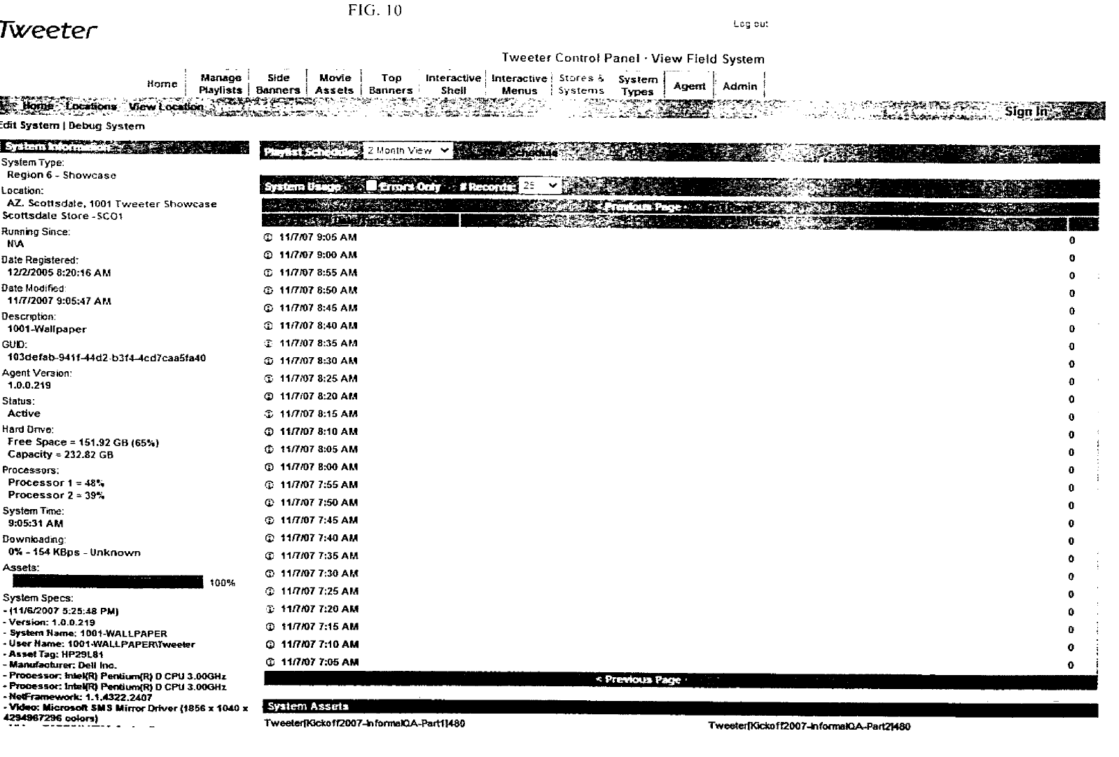

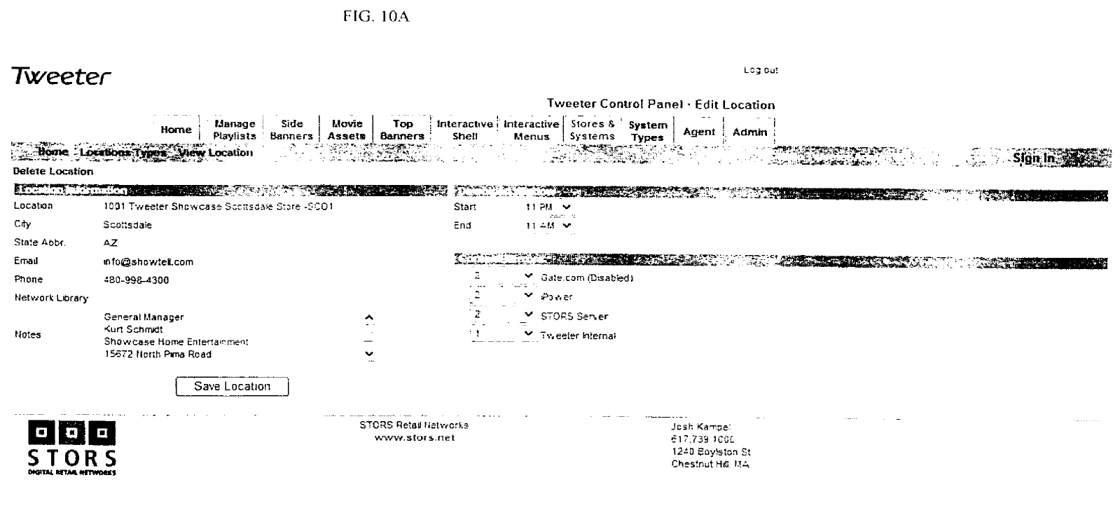

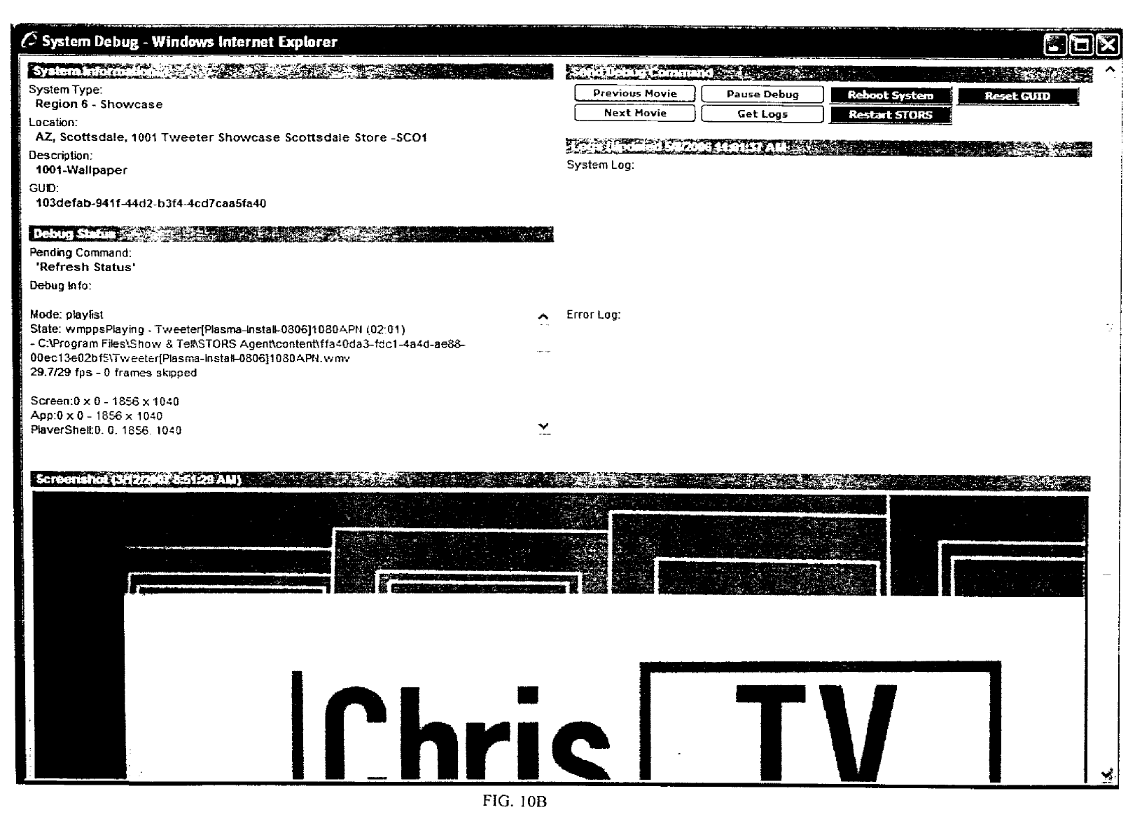

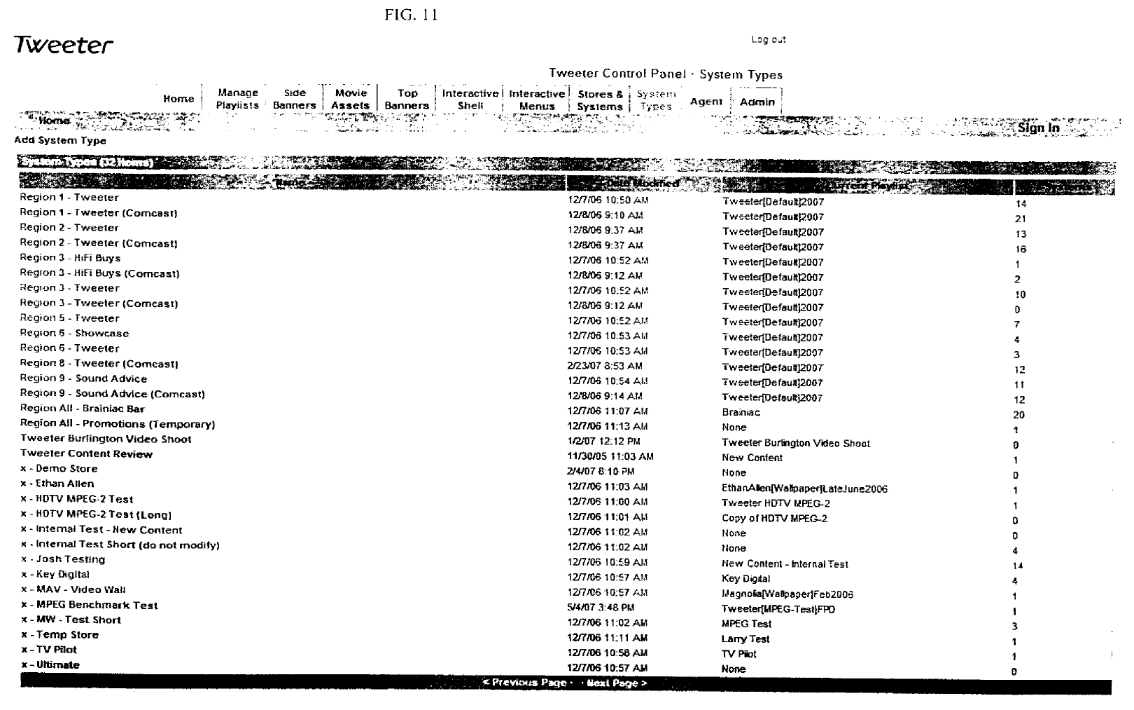

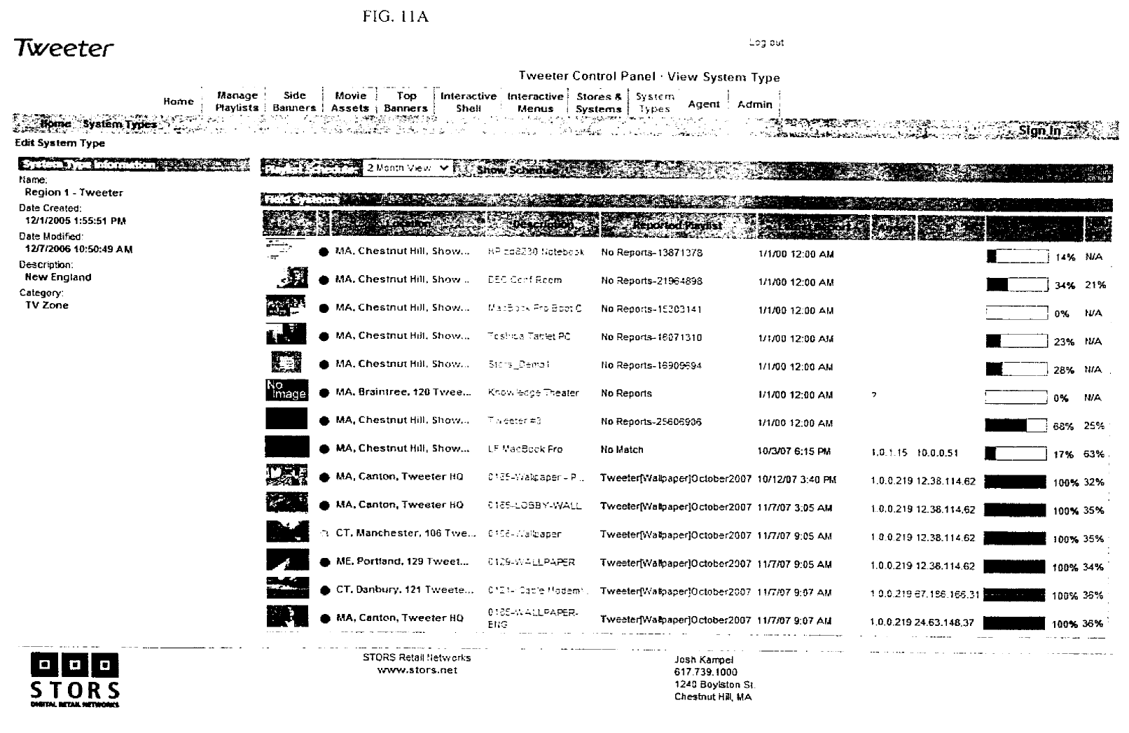

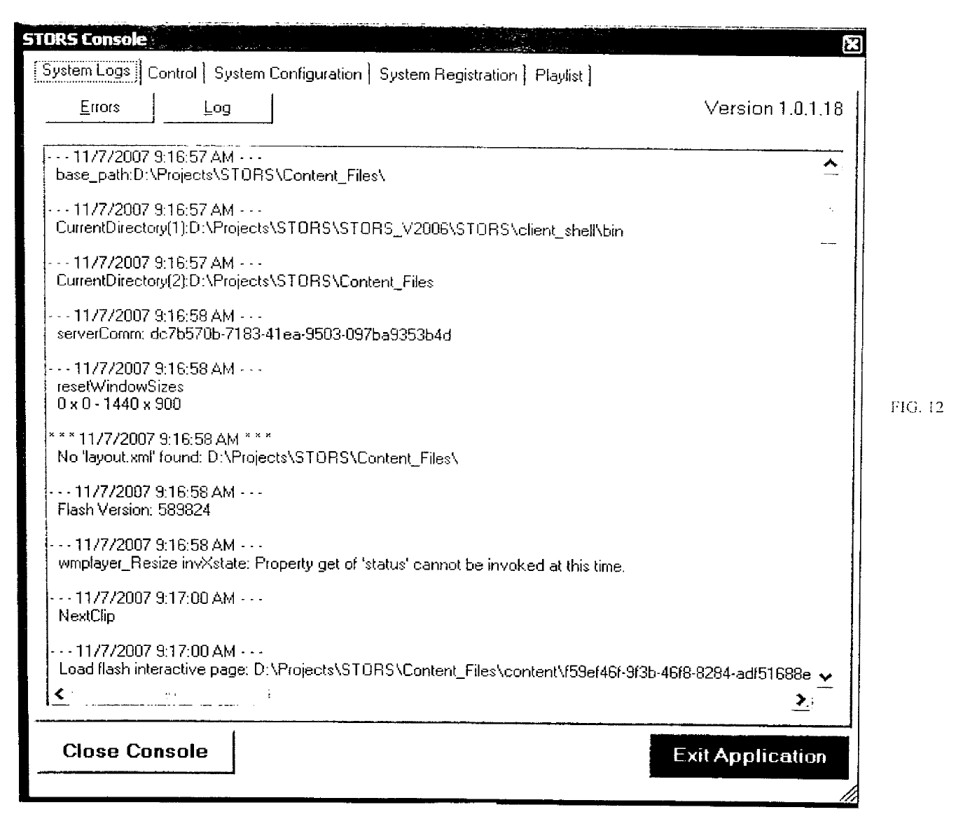

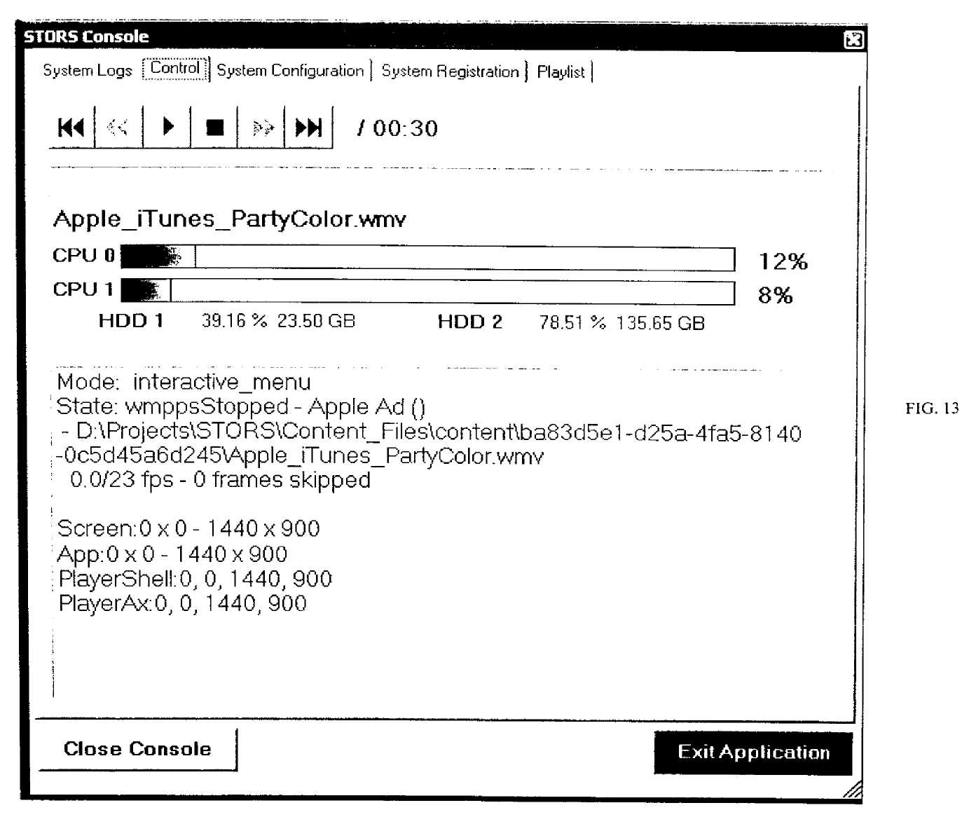

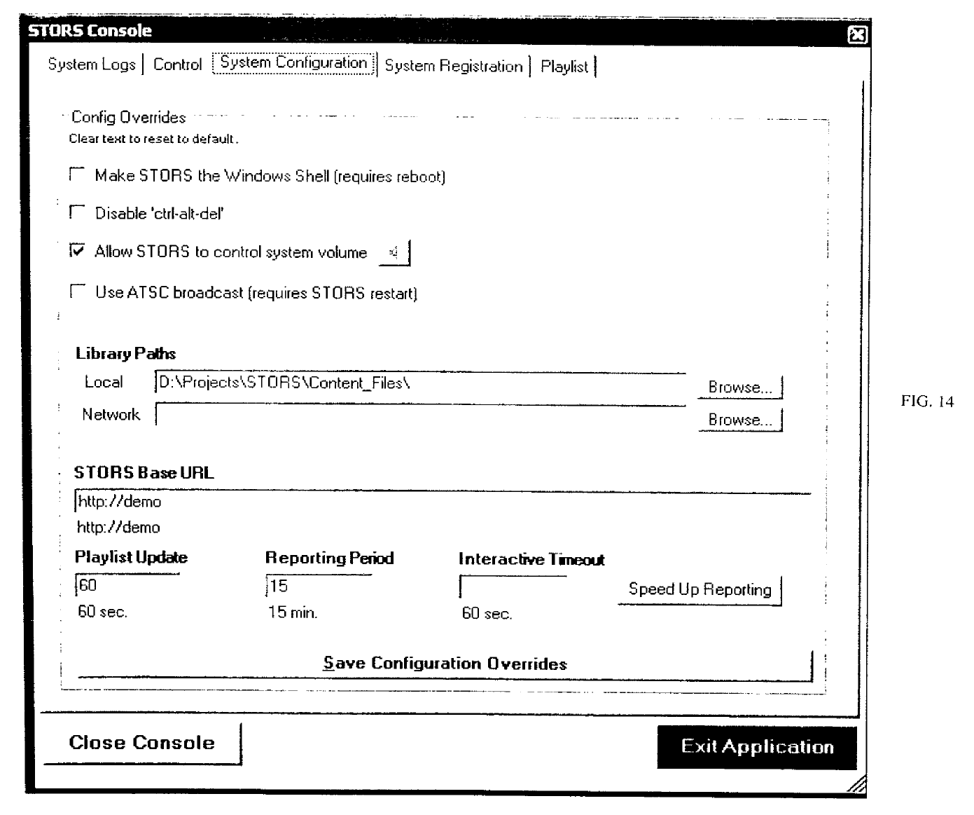

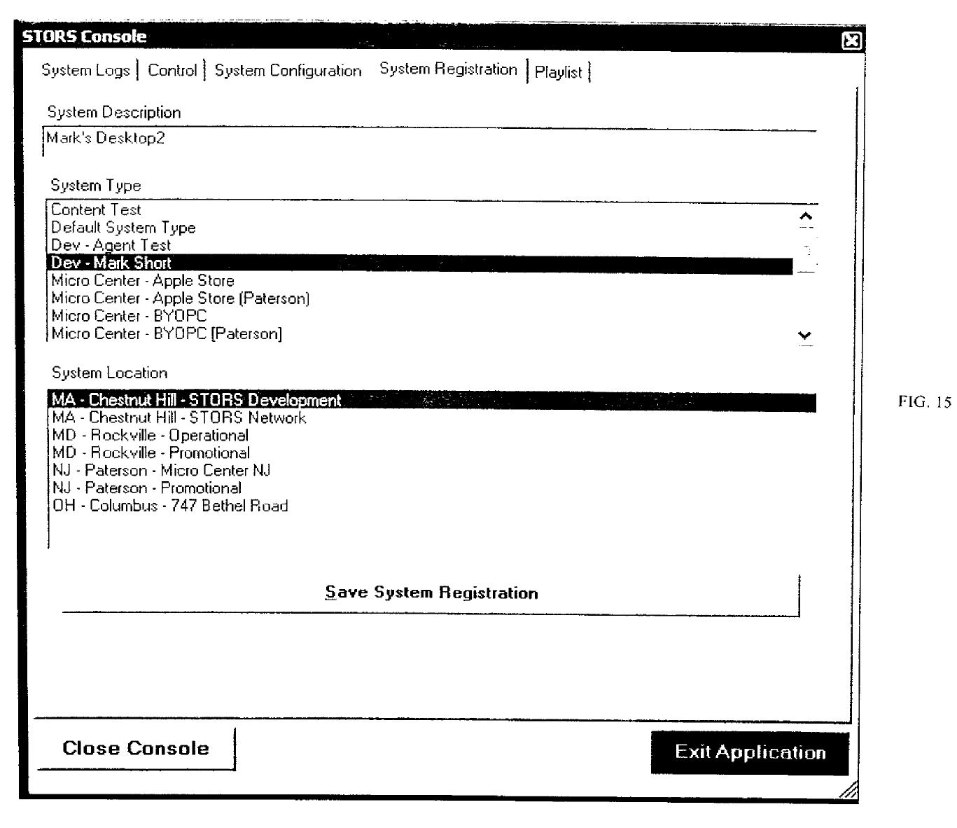

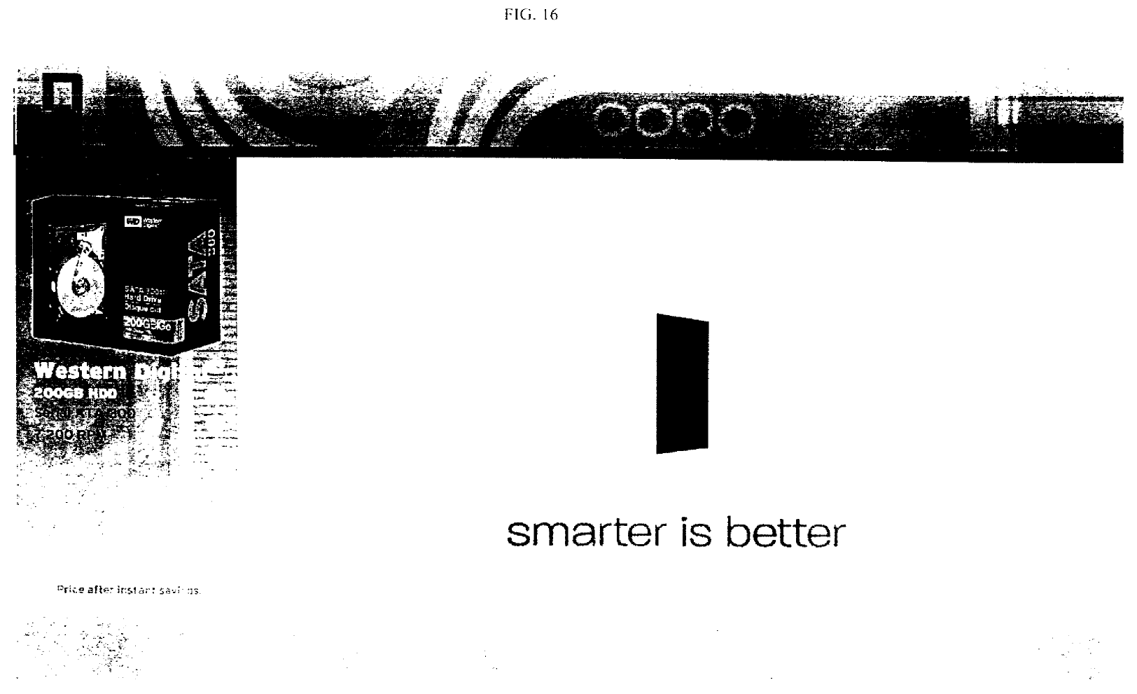

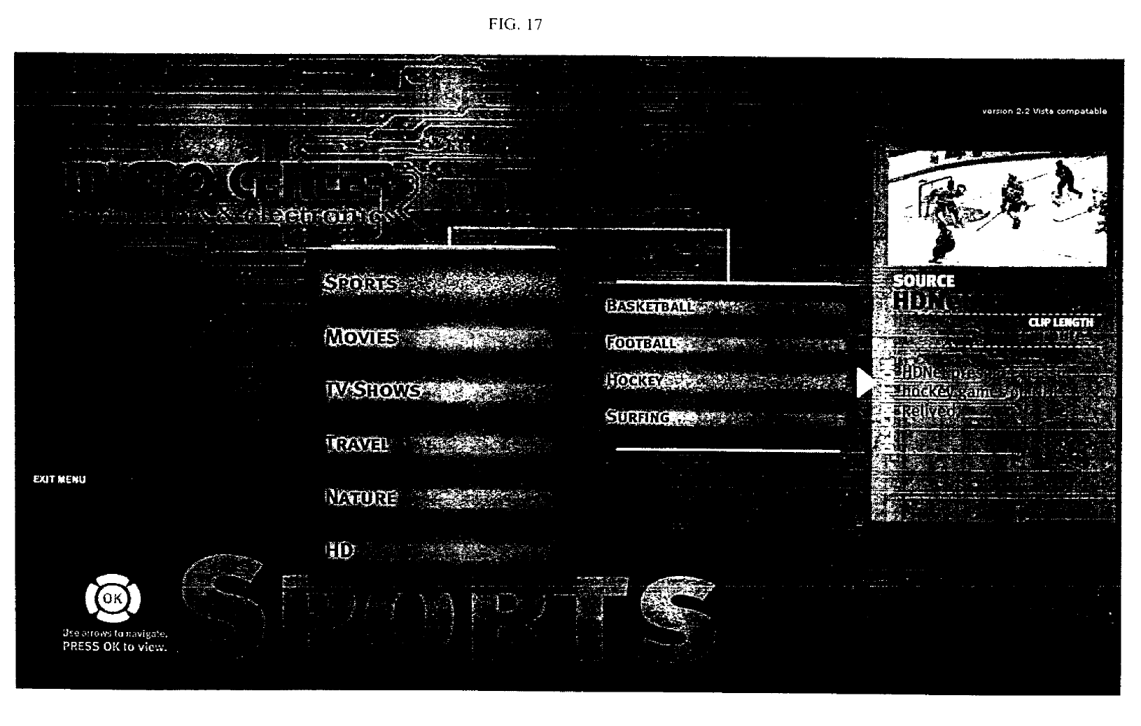

FIGS. 4-11 show administrative screens according to various embodiments of the present invention.

Each machine in the field “pings” the server periodically for various reasons, for example, to check for new content, a new executable, remote debug command, etc. These vary every 30 seconds or so for a “heartbeat” message, every 5 minutes or so for a status report, to every 10 minutes or so for a content check-in. These may all be changed as deemed necessary. Also, each system may be staggered within its check-in time-windows to ensure that the server does not have all machines hitting at the same instance.

The interactive elements greatly expand the features of an embodiment. Customers and other personnel may interact with devices in the system. For example, a customer may approach a PC and by hitting any key, start the PC into an interaction mode to allow the customer to get more information about a product, to play games, or even place orders, for example. Many different interactive modes are possible. For example, if a customer interacts with a device regarding something that is on sale, the display can inform the customer of the sale, limited remaining inventory, or offer other promotions. When a customer provides information to a sales person, a display or multiple displays in the check-out area may provide information helpful to the customer, such as the weather based on the customer's zip code. Alternatively, the display can creek and warn the customer about adverse driving conditions (such as traffic jams) between the score and the customers home town. Various types of features can be implemented that gather information (including inventory, promotions, sales quotas, delivery or other charges, etc.), and then use various determining factors (such as rule based systems or fuzzy logic systems) to analyze and present helpful information to the customers or store personnel.

The present invention provides for a segment of branding and advertisement for internal customer messaging and external non-customer advertisers. For example, an ad inventory allows the present invention to identify, segment, coordinate and track advertisement time availability and usage in a deployed fleet. As for targeting, the present invention, based on external sensors such as environmental sensors like pollen and rain, can use different advertisement;, and play them to optimize targeting of purchasers demand at that time. In addition, an ad asset playback may be tracked and reports generated on data are used to verify that ads played in order to adhere with the compliance feature of the present invention. In addition, the present invention can aid billing through combining compliance, interactivity, and usage statistics into a revenue model.

The present invention is also capable of adding tools and value to sales. For example, as part of the interactivity, the present invention may provide sales tools that complement a sales staff by providing examples, sample clips, or other tools to increase purchases. By tying in both data from the present invention itself, as well as external information sources, such as an inventory system, the system of the present invention may create custom sales promotions intended to increase in store sales. Also, the system of the present invention is uniquely designed so that it may operate within a customer's existing IT infrastructure. To minimize the bandwidth impact on a network, the present invention may restrict the bandwidth intensive downloads to a specified time during each day.

Also, in an embodiment of the present invention, there is no requirement for any adjustments to normal security policies. In this embodiment, activity begins at each individual system and utilizes standard web transmissions, which are designed to pass through firewalls and web proxies. In a privileged access embodiment of the present invention, access to the agent side configuration and management system are both access controlled and based on a privilege basis. Different user classes have both different access and rights to view data. For example, some users only have access to view playlists, while others may edit them. Furthermore, visibility of the asset storage area may also be controlled by user class.

Although the present invention has been shown and described with respect to illustrative embodiments thereof, various other changes, omissions and additions in the form and detail thereof may be made therein without departing from the spirit and scope of the invention.

1. A method of publishing a media set, said method comprising:
selecting a publishing platform;
compiling a set of data regarding said media set;
analyzing said set of data;
creating a playlist based on said analyzing said set of data for said media set; and
publishing said media set on said publishing platform.

2. The method of claim 1, wherein said data set includes a status report and a usage report.

3. The method of claim 1, wherein said data set includes a status report or a usage report.

4. The method of claim 1, wherein said set of data is updated periodically.

5. The method of claim 1, wherein said set of data is updated automatically.

6. The method of claim 1, wherein said publishing platform is a television or a plasma television.

7. The method of claim 1, wherein said publishing platform is a computer, either a desktop computer or a laptop computer.

8. The method of claim 1, wherein said publishing platform may be a camera, a kiosk or an audio only dev ice.

9. The method of claim 2, wherein said status and usage reports are viewed by a system administrator.

10. The method of claim 1, wherein said publishing is implemented over a secured web based platform

11. A system for publishing a media set, the system comprising:
a platform to display said media set;
a system administrator, said system administrator views and analyzes a data set;
a content administrator, said content administrator analyzes said data set;
a content publisher, said content publisher creates, edits and manages said data set for said media set; and
a publishing manager, said publishing manager views and publishes said media set on said publishing platform.

12. The system of claim 11, wherein said media set may be displayed on any media displayer, including a television.

13. The system of claim 11, wherein said media set may be displayed on a computer.

14. The system of claim 11, wherein said media set may be displayed on a camera.

15. The system of claim 11, wherein a storage unit is connected to said system via a web-based connection.

16. The system of claim 11, wherein said content publisher creates and edits said data set, assigns content to said data set, and associates said data set with said platform appropriately.

17. The system of claim 11, wherein said system provides for automatic checks and updates to said data set.

18. The system of claim 11, wherein said system provides for reports on usage and updates versions of said media.

19. The system of claim 11, wherein said data set includes a status report and a usage report.

20. The system of claim 11, wherein said data set is updated periodically.

21. The system of claim 11, wherein said data set is updated automatically.

22. A method for displaying a media set, said method comprising: analyzing a set of data;
selecting a publishing platform;
creating a playlist based on said analyzing said set of data;
automatically updating said set of data; and
publishing said data on said publishing platform.

23. A system for displaying a media set, the system comprising:
a means for choosing a platform to display said media set;
a means for creating, editing and managing said media set; and
a means for viewing and publishing said media set.
